(19) United States
(12) Patent Application Publication
(10) Pub. No.: US 2006/0212186 A1
(43) Pub. Date: Sep. 21, 2006

(54) Method and apparatus for scheduling maintenance of way

(76) Inventors: Joseph Wesley Philp, Indialantic, FL (US); Mitchell Scott Wills, Melbourne, FL (US); Joanne Maceo, Rockledge, FL (US)

Correspondence Address: DUANE MORRIS LLP, Suite 700, 1667 K Street, N.W., Washington, DC, 20006, US

(21) Appl. No.: 11/342,855

(22) Filed: Jan. 31, 2006

Related U.S. Application Data
(63) Continuation-in-part of application No. 10/785,059, filed on Feb. 25, 2004.
(60) Provisional application No. 60/449,849, filed on Feb. 27, 2003.

(51) Int. Cl. G01C 21/00

(52) U.S. Cl. 701/19; 701/200

(57) ABSTRACT

A scheduling system and method for moving plural objects through a multipath system described as a freight railway scheduling system. The scheduling system utilizes a resource scheduler to minimize resource exception while at the same time minimizing the global costs associated with the solution. The achievable movement plan can be used to assist in the control of, or to automatically control, the movement of trains through the system, and is particularly useful in optimizing the value of trains moved against the penalty for postponement of maintenance of the right of way.

### RELATED APPLICATIONS

This application is a continuation in part of application Ser. No. 10/785,059 filed Feb. 25, 2004, claiming the benefit of U.S. Provisional Application 60/449,849 filed on Feb. 27, 2003.

This application is also one of the below listed applications being concurrently filed:

GEH01 00166 application Ser. No. ______ entitled “Scheduler and Method for Managing Unpredictable Local Trains”;

GEH01 00168 application Ser. No. ______ entitled “Method and Apparatus for Coordinating Railway Line-Of-Road and Yard Planners”;

GEH01 00169 application Ser. No. ______ entitled “Method and Apparatus for Selectively Disabling Train Location Reports”;

GEH01 00170 application Ser. No. ______ entitled “Method and Apparatus for Automatic Selection of Train Activity Locations”;

GEH01 00171 application Ser. No. ______ entitled “Method and Apparatus for Congestion Management”;

GEH01 00172 application Ser. No. ______ entitled “Method And Apparatus For Automatic Selection Of Alternative Routing Through Congested Areas Using Congestion Prediction Metrics”; and

GEH01 00173 application Ser. No. ______ entitled “Method and Apparatus for Estimating Train Location”.

The disclosure of each of the above referenced applications including those concurrently filed herewith is hereby incorporated herein by reference.

### BACKGROUND OF THE INVENTION

The present invention relates to the scheduling of movement of plural units through a complex movement defining system, and in the embodiment disclosed, to the scheduling of the movement of freight trains over a railroad system, particularly the scheduling of maintenance of way services.

Systems and methods for scheduling the movement of trains over a rail network have been described in U.S. Pat. Nos. 6,154,735, 5,794,172, and 5,623,413, the disclosure of which is hereby incorporated by reference.

As disclosed in the referenced patents and applications, the complete disclosure of which is hereby incorporated herein by reference, railroads consist of three primary components (1) a rail infrastructure, including track, switches, a communications system and a control system; (2) rolling stock, including locomotives and cars; and, (3) personnel (or crew) that operate and maintain the railway. Generally, each of these components are employed by the use of a high level schedule which assigns people, locomotives, and cars to the various sections of track and allows them to move over that track in a manner that avoids collisions and permits the railway system to deliver goods to various destinations.

As disclosed in the referenced applications, a precision control system includes the use of an optimizing scheduler that will schedule all aspects of the rail system, taking into account the laws of physics, the policies of the railroad, the work rules of the personnel, the actual contractual terms of the contracts to the various customers and any boundary conditions or constraints which govern the possible solution or schedule such as passenger traffic, hours of operation of some of the facilities, track maintenance, work rules, etc. The combination of boundary conditions together with a figure of merit for each activity will result in a schedule which maximizes some figure of merit such as overall system cost.

As disclosed in the referenced applications, and upon determining a schedule, a movement plan may be created using the very fine grain structure necessary to actually control the movement of the train. Such fine grain structure may include assignment of personnel by name as well as the assignment of specific locomotives by number and may include the determination of the precise time or distance over time for the movement of the trains across the rail network and all the details of train handling, power levels, curves, grades, track topography, wind and weather conditions. This movement plan may be used to guide the manual dispatching of trains and controlling of track forces, or provided to the locomotives so that it can be implemented by the engineer or automatically by switchable actuation on the locomotive.

The planning system is hierarchical in nature in which the problem is abstracted to a relatively high level for the initial optimization process, and then the resulting course solution is mapped to a less abstract lower level for further optimization. Statistical processing is used at all levels to minimize the total computational load, making the overall process computationally feasible to implement. An expert system is used as a manager over these processes, and the expert system is also the tool by which various boundary conditions and constraints for the solution set are established. The use of an expert system in this capacity permits the user to supply the rules to be placed in the solution process.

Currently, a dispatcher's view of the controlled railroad territory can be considered myopic. Dispatchers view and processes information only within their own control territories and have little or no insight into the operation of adjoining territories, or the railroad network as a whole. Current dispatch systems simply implement controls as a result of the individual dispatcher's decisions on small portions of the railroad network and the dispatchers are expected to resolve conflicts between movements of objects on the track (e.g. trains, maintenance vehicles, survey vehicles, etc.) and the available track resource limitations (e.g. limited number of tracks, tracks out of service, consideration of safety of maintenance crews near active tracks) as they occur, with little advanced insight or warning.

One of the dispatchers' problems is the scheduling of maintenance of the tracks and the other resources of the system. The tracks themselves may differ widely in type and those tracks intended for high speed use typically require more and different types of maintenance than those used only for local low speed train traffic. Other considerations include the availability and location of the various types of maintenance resources and maintenance crews.

As disclosed in the referenced applications, each resource used in each activity in the system has a cost element associated with it. The cost includes the actual cost of effecting the maintenance, including both equipment and personnel cost that may vary widely depending on the time at which the maintenance is effected. However, there is an inherent cost associated with the maintenance of track, i.e., the cost associated with the non-use of the resource while the maintenance in being effected. For example, a train delayed by maintenance on the track may incur significant financial penalties because of the delay. Thus, it may be more cost effective to perform maintenance at a time when the maintenance is relative expensive (e.g., at night) if the delay in train traffic which would result from less expensive maintenance during the day would be relatively more expensive due to contractual delivery considerations.

There is a further penalty in delaying maintenance in that the all flexibility in the timing of the maintenance may be lost through delay, i.e., routine low priority maintenance increases in priority over time and may become a very high priority because of safety issues.

However, previously maintenance has not been scheduled as part of the movement plan and thus has not been considered in the optimization of the system. It has been the practice to consider railway maintenance activity a prescheduled fixed constraint around which the train schedule should be moved. Such constraint may be that so many hours of maintenance activity on a given section of track must be performed and the trains are scheduled to minimize costs of the operation of the trains without consideration of the costs associated with delaying maintenance in order to accommodate the movement of the trains.

In scheduling maintenance, known scheduling planners have not heretofore weighed the cost of performance of the maintenance against the cost of delaying the maintenance, and it is accordingly an object of the present invention to schedule maintenance activities in the furtherance of rational utilization goals and the profitability of the overall transportation system.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWING

FIG. 1 is a simplified flow chart illustrating one embodiment for planning maintenancece of way activities.

### DETAILED DESCRIPTION

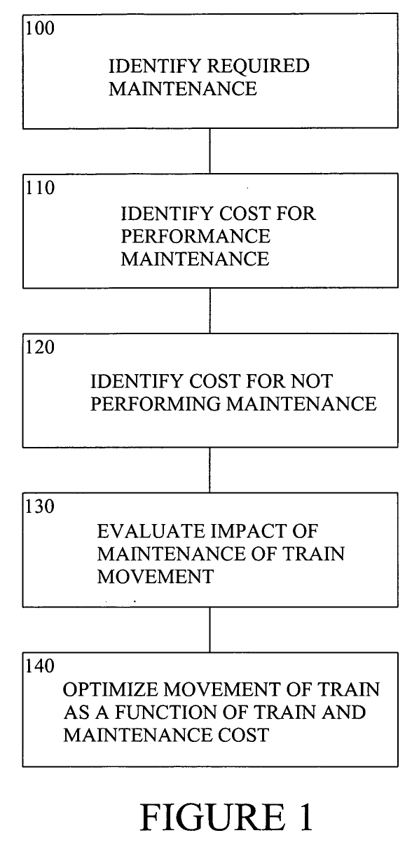

The apparatus disclosed in the referenced applications may be used in the performance of the methods disclosed herein. With reference to FIG. 1, a list of desired maintenance activities may be identified for a planning cycle 100. The costs for performing the maintenance can be identified 110 including maintenance crew costs, as well as impact on the costs of the planned train movement for removing any track resources from service for the maintenance period. The costs for not performing the maintenance are also identified 120 including maintenance crew costs for idling the maintenance crew, and the increased costs in train movement that may result from not performing the maintenance. For example, if maintenance on a section of track is not performed, it may be necessary to lower the allowable speed limit for that section of the track. A lower speed limit translates to a longer transit time for each train scheduled to use that section of the track and thus may result in increased operating costs for using that section of track. The costs for not performing the required maintenance may exceed the cost for performing the maintenance once all factors are considered. Thus, the present application considers not only the costs of performing the scheduled maintenance, but also the cost of not performing the maintenance in determining the optimal schedule of train movement that minimizes overall system cost.

By way of another example, a significant portion of the costs associated with scheduling maintenance is the cost of the crew to perform the maintenance. The availability of work crews is tightly controlled and dictated by collective employment contracts which limit the amount and type of work to be performed by a work crew in a given day. The idling of a work crew while a train passes through a maintenance area entails costs for not performing the maintenance. The present application can be used to more efficiently utilize the maintenance crews limited number of available hours by evaluating the costs of not performing maintenance and planning maintenance that facilitates the maximum utilization of the maintenance crew.

The impact of the maintenance to the train movement plan, including contractual penalties for any delay, may then be evaluated and determined 130. The cost of any train delay caused by each maintenance activity may then added to the previously determined cost of the maintenance activity, and the total maintenance cost used in the creation of a comprehensive plan for optimizing of the cost of operating the system inclusive of both train movement and maintenance 140. This method of scheduling maintenance of way may be implemented using computer usable medium having a computer readable code executed by special purpose or general purpose computers.

One of the fundamental principals in optimization is that each element of the operation has associated with it some incremental cost in the criteria being optimized. Incremental cost can be fuel cost, hourly cost of personnel, hourly use cost of locomotives or hourly use cost times distance traveled of locomotives. The actual incremental cost factor, including nonlinearities and penalties, are considered in the present application so that it is the global or the overall optimization for cost which controls rather than predetermined priorities (considered only as cost factors). The total cost includes the operating costs such as fuel and rolling stock utilization as well as the delivery costs caused by contractual terms and commitments. In the past maintenance of way was scheduled around the planned movement of the trains through negotiations between the train movement supervisor and the dispatcher, without consideration of the costs for performing the maintenance as well as the cost for not performing the maintenance. The present application considers both the costs for performing the maintenance as well as the cost for not performing the maintenance as factors to be considered when planning train movement and thus results in an optimized schedule which takes maintenance into account.

While preferred embodiments of the present invention have been described, it is understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. In a railroad system in which plural trains are moved along a network of railway tracks under control of a dispatcher assisted by a scheduling computer prepared movement plan that assigns resources to activities and considers the cost of each activity and assigned resources in scheduling the movement of trains over the tracks, the method of scheduling maintenance of way for the railway tracks comprising:
(a) identifying maintenance of way activities desired to be performed;
(b) evaluating the costs for performing the maintenance of way;
(c) evaluating the costs for not performing the maintenance of way;
(d) evaluating the impact of maintenance of way on train movement; and
(e) planning the movement of the trains as a function of the maintenance and train movement costs.

2. The method of claim 1 wherein the costs for performing maintenance of way include the costs for making a section of railway track unavailable to the trains during maintenance.

3. The method of claim 1 wherein the costs for not performing maintenance include the costs for an idle maintenance crew.

4. The method of claim 1 wherein the costs for not performing maintenance include the costs of constraints placed on the utilization of a section of track where maintenance has not been performed.

5. The method of claim 4 wherein the constraint includes a lower speed limit.

6. The method of claim 4 wherein the constraint is a restriction of certain types of trains.

7. The method of claim 1 wherein the step of planning the movement of trains optimizes the global costs of moving the trains and performing the maintenance.
